(19) United States
(12) Patent Application Publication
(10) Pub. No.: US 2024/0129748 A1
(43) Pub. Date: Apr. 18, 2024

(54) UNLICENSED SPECTRUM COMMUNICATION CONVERTER SYSTEM AND METHOD

(71) Applicant: WiFrost, Inc., Palo Alto, CA (US)

(72) Inventors: Tao Chen, Palo Alto, CA (US); Muhammad Qayyum, Palo Alto, CA (US); Hanxi Chen, Palo Alto, CA (US)

(73) Assignee: WiFrost, Inc., Palo Alto, CA (US)

(21) Appl. No.: 18/378,982

(22) Filed: Oct. 11, 2023

Related U.S. Application Data
(60) Provisional application No. 63/415,842, filed on Oct. 13, 2022.

(51) Int. Cl. H04W 16/14

(52) U.S. Cl. CPC H04W 16/14; H04W 84/042

(57) ABSTRACT

An unlicensed spectrum communication converter system and method allows 3GPP compliant integrated circuits (LTE, 5G) to be used in a unlicensed spectrum band communication system. In one implementation, each of the unlicensed spectrum base station and unlicensed spectrum user equipment (UE) may include a translation layer. The unlicensed spectrum communication converter system and method may be used with various unlicensed spectrums including, for example, television whitespace (TVWS) unlicensed spectrum, citizens broadband radio service (CBRS) and Wi-Fi (including all UNII bands from UNII-1 to UNII-8).

### PRIORITY CLAIMS/RELATED APPLICATIONS

This application claims the benefit under 35 USC 119(e) to U.S. Provisional Patent Application Ser. No. 63/415,842 filed Oct. 13, 2022 and entitled “Unlicensed Spectrum Communication Converter System and Method”, the entirety of which is incorporated herein by reference.

### FIELD

The disclosure relates to converting a 3GPP device (baseband processor or radio front end) for use with unlicensed spectrum communications.

### BACKGROUND

Each different communication system that uses a different frequency band or frequency bands requires a baseband processor and its own unique radio front end (together an RF chip set). For example, an LTE system or 5G system each require their own RF chip sets since each system uses a different frequency band and the RF chip set needs to be custom designed for each frequency band. It is very expensive and time consuming to design a new chip set for each licensed spectrum band system, such as LTE or 5G. However, for these licensed spectrum systems in which millions of handset units are sold, the cost and time to design and fabricate these RF chip sets are justified.

Most communication systems have a plurality of base stations that communicate via the frequency band/bands with a plurality of user devices. The 3GPP standard refers to base stations as eNodeB (eNBs) and each user device as user equipment (UE). Each user device may also be called customer premises equipment (CPE). Each of these different naming conventions refer to the same elements of the communication system.

In addition to these licensed spectrum systems, there are also communication systems that use unlicensed spectrum. Examples of the unlicensed spectrum include television whitespace (TVWS), citizens broadband radio service (CBRS), and bands utilized by Wi-Fi technology, such as “Industrial Scientific & Medical (ISM)” and “Unlicensed National Information Infrastructure (UNIT)” bands. Unlike the licensed spectrum systems, unlicensed spectrum systems cannot justify the cost and time to design and fabricate the RF chip sets. Thus, it is desirable to be able to use a licensed spectrum RF chip set (that operates at a particular licensed frequency band) for an unlicensed spectrum communication system that operates using an unlicensed spectrum band and it is to this end that the disclosure is directed.

### BRIEF DESCRIPTION OF THE DRAWINGS

FIG. 1 illustrates an unlicensed spectrum communication system with a representative base station and user equipment (UE);

FIGS. 2A and 2B illustrate more details of an implementation of the base station in FIG. 1;

FIG. 3 illustrates an example of the base station configuration example;

FIG. 4 illustrates more details of an implementation of the user equipment (UE) in FIG. 1;

FIG. 5 illustrates an example of the UE configuration example;

FIG. 6 illustrates another implementation of a 5G/LTE to unlicensed spectrum translation system;

FIG. 7 illustrates a method for communicating data over an unlicensed spectrum band using an unlicensed spectrum translation system; and

FIG. 8 illustrates a method for receiving data over an unlicensed spectrum band using an unlicensed spectrum translation system.

### DETAILED DESCRIPTION OF ONE OR MORE EMBODIMENTS

The disclosure is particularly applicable to a television whitespace (TVWS) unlicensed spectrum system that uses LTE or 5G integrated circuits and it is in this context that the disclosure will be described. It will be appreciated, however, that the unlicensed spectrum communication converter system and method may be used with any unlicensed spectrum including the n77 spectrum band, the citizens broadband radio service (CBRS) and Wi-Fi (including all Unlicensed National Information Infrastructure (UNIT) bands from UNII-1 to UNII-8 or “Industrial Scientific & Medical (ISM)” bands) and any other known or yet to be developed unlicensed spectrum communication systems. Furthermore, the unlicensed spectrum 3GPP communication converter system and method may be implemented in other manners consistent with the operation of the translation layer example embodiment described below in which a 3GPP compliant integrated circuit can be used with an unlicensed spectrum communications system. The TVWS spectrum may be between 70 to 698 MHz, the CBRS spectrum may be between 3550-3700 MHz, the n77 spectrum band is a frequency band designated by the 5G NR standard that covers 3300 to 4200 MHz, and WiFi spectrum may be between 2400-2484 MHz and 4900-6450 MHz.

In one embodiment, the system and method may convert an E-UTRA (an air interface of 3rd Generation Partnership Project (3GPP) Long Term Evolution (LTE) upgrade path for mobile networks) Absolute Radio Frequency Channel Number (EARFCN) to enable 5G and LTE integrated chips to be used in any unlicensed band. In one implementation, the conversion may be accomplished by a translation of the LTE and 5G baseband processor interface with the RF Front end transceiver. This technique allows any LTE or 5G baseband processor configured for a licensed 3GPP band to operate in any unlicensed frequency supported by the transceiver. This implementation works for both Base Station and User Equipment (UE). Furthermore, the technique is transparent to customers that do not have knowledge of how or if this process exists.

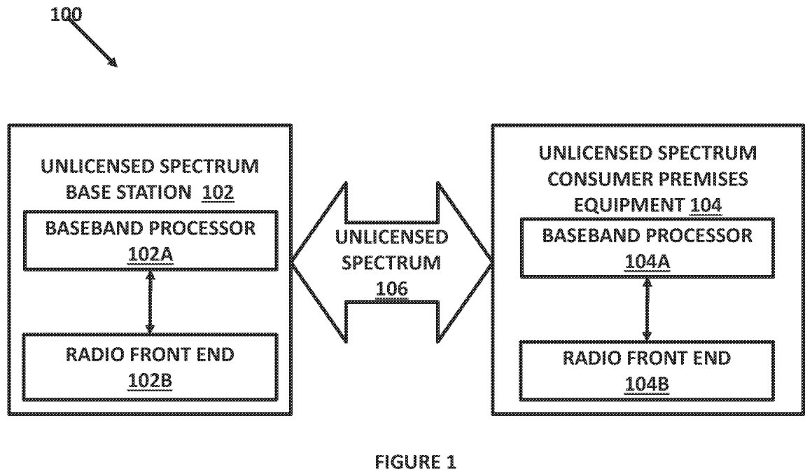

FIG. 1 illustrates an unlicensed spectrum communication system 100 with a representative base station 102 and the user equipment (UE) 104 that communicate with each other using one or more unlicensed spectrum band(s) 106. An actual deployment of the unlicensed spectrum communication system 100 would involve a plurality of base stations and a plurality of UEs that communicate with each other, but FIG. 1, for illustration purposes and clarity, shows just a single unlicensed spectrum base station 102 and a single unlicensed spectrum UE 104. The unlicensed spectrum base station 102 operates like a 3GPP base station (eNB) in that it receives RF communications from the UE 104 and forwards that to a backend system (not shown in FIG. 1). The unlicensed spectrum UE 104 operates like a 3GPP compliant UE and is used by a user or entity to communicates with the base station 102. Each UE 104 may be a user computing device that has one or more processor(s) and integrated circuits and a plurality of lines of instructions/computer code so that each UE 104 communicates via RF signals to the base station 102 using known data and communication protocols. Each UE 104 may be a smartphone device, a personal computer, laptop computer, wireless router in a residence or building, tablet computer or any other device that is configured to connect to and communicate with the unlicensed spectrum base station 102 over the unlicensed spectrum 106.

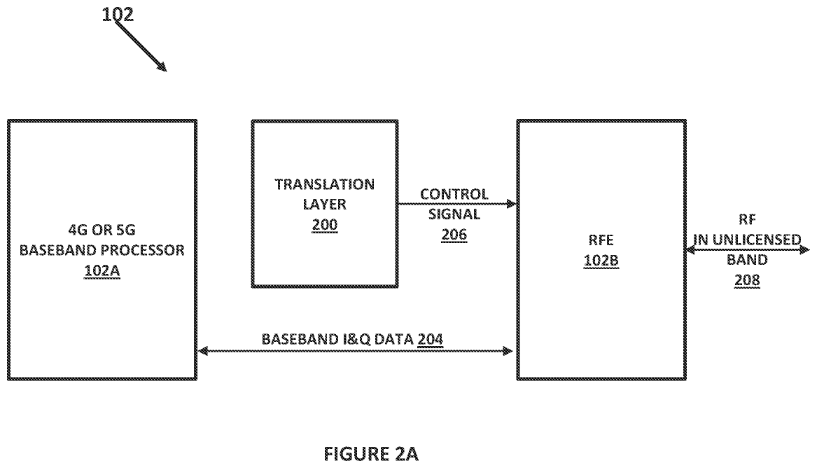

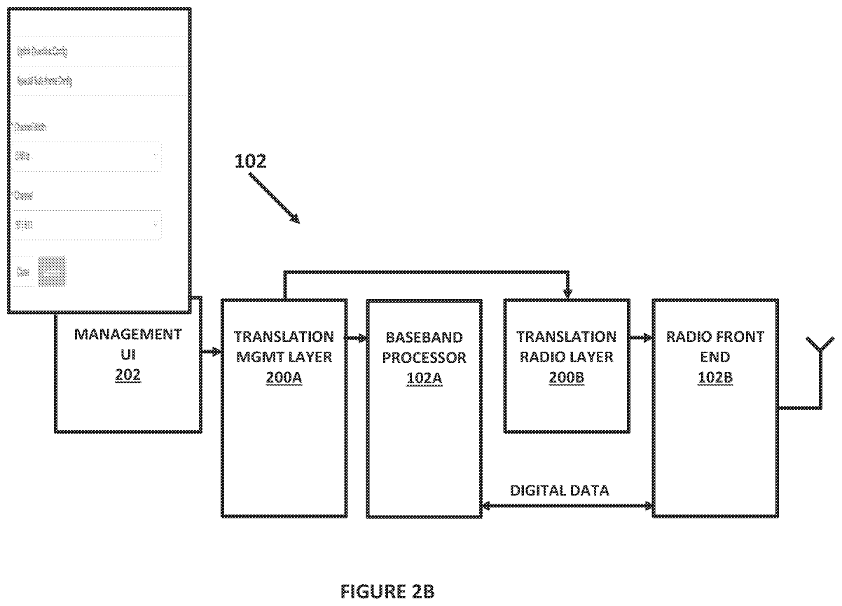

The base station 102 may have a baseband processor 102A and a radio front end (RFE) 102B that are coupled together and together implement the unlicensed spectrum communications with each UE 104. The baseband processor and RFE 102A, 102B of the base station may be a LTE or 5G 3GPP compliant integrated circuit that are commercially manufactured and sold by many companies. For example, these integrated circuits may be manufactured and sold as commercial products by various companies including Marvell, Intel, NXP, MediaTek and Qualcomm. The UE 104 may have a baseband processor 104A and a radio front end (RFE) 104B that are coupled together and together implement the unlicensed spectrum communications with each base station 102. The baseband processor and RFE 104A, 104B of the UE 104 may be integrated into a LTE or 5G 3GPP compliant system on a chip (SOC) integrated circuit that are commercially manufactured and sold by many companies. For example, these integrated circuits may be manufactured and sold as commercial products by various companies including Marvell, Intel, NXP, MediaTek and Qualcomm. The LTE or 5G 3GPP compliant integrated circuits use the LTE and 5G licensed spectrum bands and thus need to be “converted” to operate with the unlicensed spectrum 106 (that operate at a different RF frequency) as will now be discussed with reference to FIGS. 2A and 2B. If a different unlicensed spectrum or spectrum band is used, then a different translation is used (to accommodate the different unlicensed spectrum band frequency) but the same translation described above occurs.

FIGS. 2A and 2B illustrate more details of an implementation of the base station 102 in FIG. 1 that adapts a 3GPP standards compliant baseband integrated circuit 102A (in each base station 102) to operate over non-standard frequency bands (unlicensed spectrum bands) by way of (1) a translation layer 200 (that may be a plurality of lines of instructions/computer code executed by a processor) and (2) an agile Radio Front End (RFE) 102B. The translation layer 200 may provide logical up/down conversion from 3GPP compliant frequency bands to target unlicensed, non-standard band frequencies. In some embodiments, the translation layer 200 may configure the RFE of each of the base station and UE to send/receive RF signals at an unlicensed spectrum band frequency instead of the licensed spectrum band frequency. In the embodiment in FIG. 2A, the translation layer 200 may be a plurality of lines of computer code/instructions in firmware executed by the baseband processor 102A that generates control signals for the radio front end 102B. The LTE or 5G baseband processor 102A may be a 3GPP standards compliant baseband integrated circuit that transmits and receives known digital (I&Q) data 204 to/from the RFE 102B such that the baseband processor 102A is performing its processes for a 3GPP compliant frequency band and being used (without its knowledge) to send/receive digital data 204 over the unlicensed frequency spectrum.

The RFE 102B consists of a RF agile transceiver and known associated RF amplifier and filters wherein the known RF agile transceivers can operate at a wide range of RF frequencies. Examples of commercially available RF agile transceivers may be, for example, an Analog Device AD9363 or a Texas Instruments AFE7686. The RF agile transceiver 102B is able to input or output digital I&Q samples 204 to/from the Baseband processor 102A. A set of control signals 206 from the translation layer 200 causes the RFE 102B to upconvert data to transmit to the desired unlicensed RF frequency spectrum and down convert received data from the desired unlicensed RF frequency spectrum (see RF in unlicensed band 208 signal.)

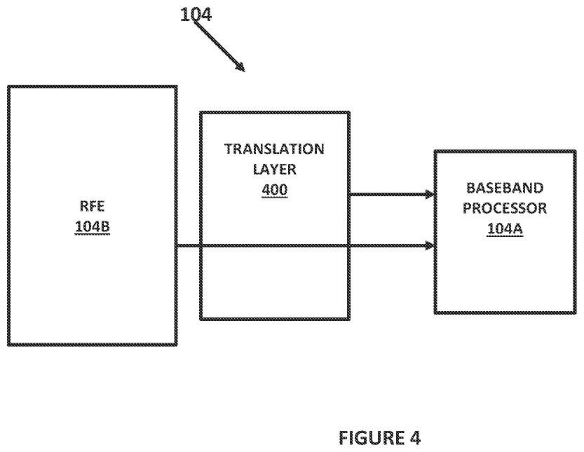

The 3GPP standards define a mapping between logical channels called E-UTRA Absolute Radio Frequency Channel Number (EARFCN) within the standards and specific channel frequencies for defined frequency bands. The Translation Layer 200 calculates the necessary offsets to map standard frequency band EARFCN to RF channels for the unlicensed spectrum that align to frequency bands that are not part of the 3GPP standard and known as “non-standard bands”. The translation layer 200 may be configured to the desired non-standard unlicensed spectrum band and operate with the same configuration on both the eNB 102 as shown in FIGS. 2A and 2B and UE 104 shown in FIG. 4 to provide both end-to-end RF & logical compatibility. In one implementation, the translation layer 200 may be integrated into the firmware for the base station 102, but may be implemented in other manners that are within the scope of this disclosure. In one implementation, the translation layer 200 may convert/translate between the two bands (LTE or 5G bands, such as band 43 to an unlicensed spectrum frequency band) using a translation process.

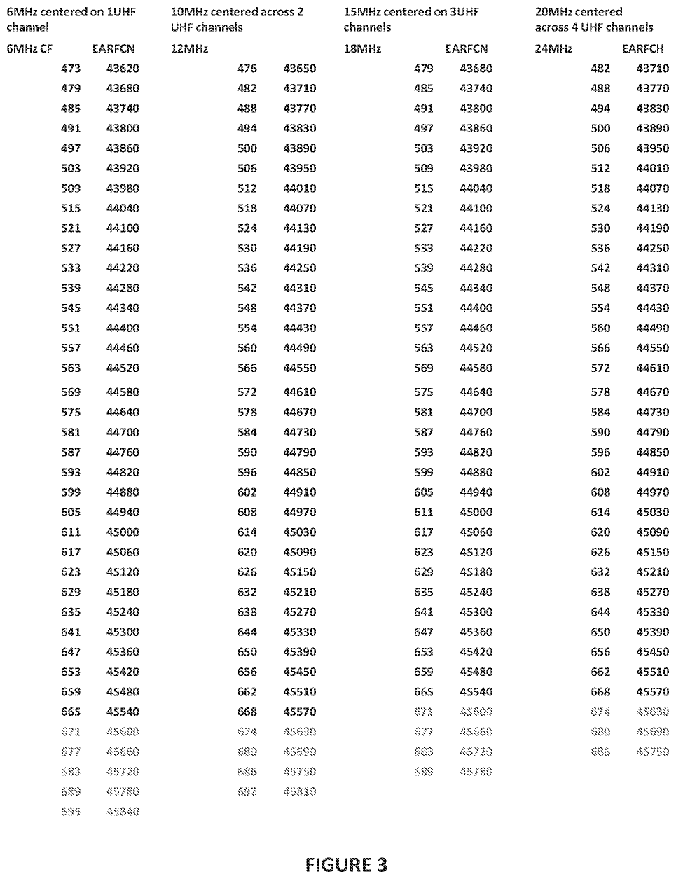

As shown in FIG. 2B, the base station 102 may further have a management user interface 202 that allows selection of the channel and bandwidth in the target unlicensed spectrum band (based on allowed channelizations). The management user interface 202 may be part of the firmware of the baseband processor 102A and executed by a processor of the baseband processor 102A. The selected channel and bandwidth (the unlicensed spectrum frequency band configuration data) may be fed into a management element 200A of the translation layer 200. The management element 200A may then determine an EARFCN (for LTE) or NR-ARFCN (for 5G) based on the configuration data (bandwidth and target center frequency) that is passed onto the baseband processor 102A and a translation radio element 200B. In one embodiment, a frequency offset may be determined, an example of which is shown in table form in FIG. 3. In some cases, there may be channels of the unlicensed spectrum band that are not compatible with the particular 3GPP band (band43 in this example) as shown in red in the table in FIG. 3 and the management user interface 202 would not allow such channels to be selected. The frequency offset may be determined using an offset process executed by the translation management element 200A. In a simple example for offsetting from band43 to the television whitespace (TVWS) frequency band, a low frequency for each band is known (3600 MHz for band43 and 470 MHz for TVWS and then an offset of 3130 MHz may be determined and used to determine the offset. For a different unlicensed spectrum bandwidth and center frequency, the offset is different but can determined in a similar manner.

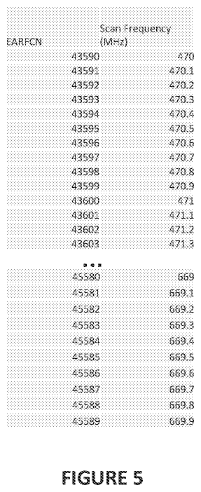

FIG. 4 illustrates more details of an implementation of the user equipment (UE) 104 in FIG. 1 with a translation layer 400 that is coupled to the baseband processor 104A of the UE. The translation layer 400 may be a plurality of lines of computer code/instructions that may be in firmware of a system on a chip (SoC) and/or the baseband processor 104A. Like the translation layer 200 in the base station, the translation layer 400 may provide logical up/down conversion from standardized band frequency (3GPP compliant) to target non-standard unlicensed band frequencies so that the LTE or 5G baseband processor and radio front end can be used to communicate over various unlicensed frequency bands including the different bands of TVWS or Wi-Fi. The translation layer 400 may configure the RF radio with EARFCN (LTE) or NR-ARFCN (5G) to a center frequency determination that supports channel scanning. The translation layer 400 may be configurable via a software update. The baseband processor 104A of the UE may scan and acquire the channel according to frequencies defined for each EARFCN (LTE) or NR-ARFCN (5G). FIG. 5 shows an example of the unlicensed spectrum frequency conversion for the UE is table form. In one implementation, the RF frequency conversion may be predetermined and then stored in lookup table (that may be part of the translation layer 400 in one implementation) that is accessed by the translation layer 400 to convert between the 3GPP compliant RF frequency and the unlicensed spectrum frequency band.

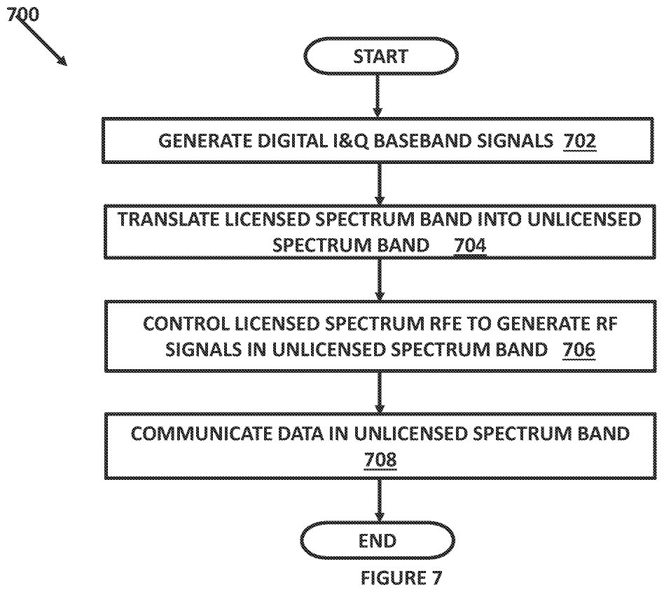

FIG. 7 illustrates a method 700 for communicating data over an unlicensed spectrum band using an unlicensed spectrum translation system. The method may be carried out by the base station when communicating data to each UE or by the UE when communicating data back to the base station. The baseband processor of the communication system may generate the well-known I &Q digital baseband signals (702). The licensed spectrum band may be translated (704) into the unlicensed spectrum band. In most embodiments, this translation process occurs during initial configuration of the base station and UE but also may be performed at other times. Based on the translation between the licensed band and the unlicensed spectrum band, the licensed spectrum RFE 102B or 104B generates, from the I &Q baseband signals, the appropriate RF signals in the unlicensed spectrum band (706) and the communicates the data over the unlicensed spectrum band (708). As discussed above, this method is seamless to the user and eliminates the cost and/or time of having to design and produce the unlicensed spectrum band specific RFEs.

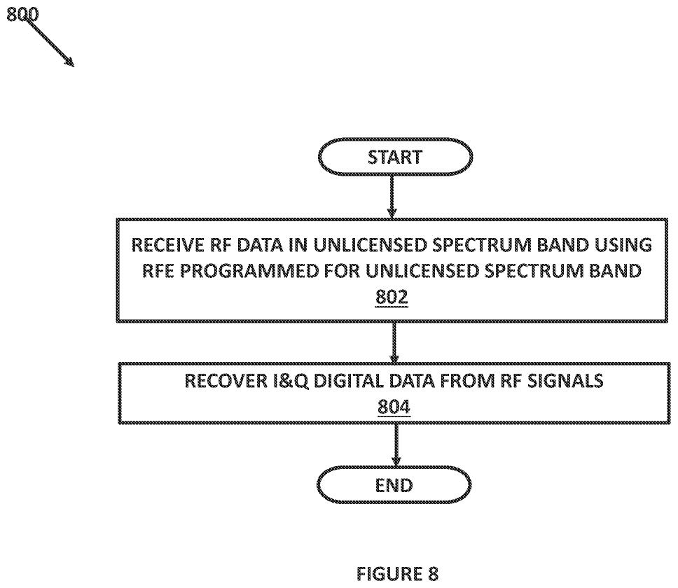

FIG. 8 illustrates a method 800 for receiving data over an unlicensed spectrum band using an unlicensed spectrum translation system. The method may be carried out by the base station when receiving data from each UE or by the UE when receiving data from the base station. In the method for receiving data, an RFE 102B, 104B receives RF data on the unlicensed spectrum band (802). The RFE has been previously sent control signals so that the RFE can accept the unlicensed spectrum band RF signals. The RFE then recovers the I& Q data signals from the RF signals (804). Similar to the transmission method above, this method is seamless to the user and eliminates the cost and/or time of having to design and produce the unlicensed spectrum band specific RFEs.

### Alternative Implementations

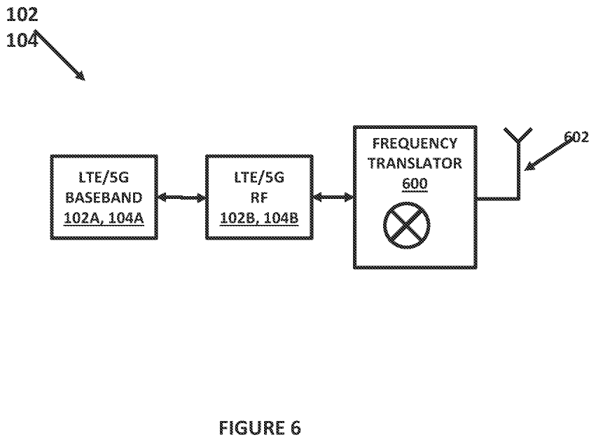

The unlicensed spectrum communication converter system and method can be implemented in various different ways. The first implementation is shown in FIGS. 2A-5 and described above. A second implementation of the unlicensed spectrum communication converter system and method is shown in FIG. 6. FIG. 6 illustrates another implementation of a licensed spectrum (5G/LTE) to unlicensed spectrum translation system with a hardware frequency converter 600 in which both the eNB 102 and UE 104 have the hardware-based frequency translator 600 that is connected to an antennae 602. The hardware-based frequency translator 600 converts the LTE or 5G RF signals generated by the radio front end 102B, 104B into the unlicensed spectrum frequency band RF signals and communicates those unlicensed spectrum band RF signals over the antennae 602. Thus, the frequency translator 600 is configured to up/down convert transmit/receive frequencies according to separation between standardized band in use and target non-standard unlicensed spectrum band(s). This alternative implementation has limitations due to difficulty with phase & frequency synchronization and a loss of performance due to additional RF processing.

A second alternative implementation may integrate a new unlicensed band into firmware or SoC for the base station and UE and get approval by 3GPP that may be known as a full-stack non-standard implementation. In this implementation, a non-standard band plan (for the unlicensed frequency band) may be defined to be implemented across all layers of eNB 102, UE 104 and the evolved packet core (EPC) stack. This implementation requires access to full-stack source code (open source or commercial) and requires complete baseband and RF implementation. The eNB 102 could be implemented using software-defined (processor) or FPGA based approach while the UE 104 would require software-defined (processor) or custom SoC (non COTS) implementation.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A method for communicating over an unlicensed spectrum band, comprising:
providing a base station having a 3GPP compliant baseband processor and a 3GPP compliant radio front end (RFE) coupled to each other that communicates over a licensed spectrum band with a piece of user equipment having a 3GPP compliant baseband processor and a 3GPP compliant RFE;
configuring, by a translation layer in of the base station and the piece of user equipment, each of the RFEs in the base station and the piece of user equipment from a licensed spectrum band to an unlicensed spectrum band;
receiving, from the baseband processor of the base station, a set of data signals at the RFE of the base station;
generating, at the RFE of the base station based on the received set of data signals, a radio frequency (RF) signal at a frequency of the unlicensed spectrum band; and
communicating the set of digital data from the base station to the piece of user equipment using the unlicensed spectrum band.

2. The method of claim 1 further comprising receiving an RF signal, at the piece of user equipment, at the frequency of the unlicensed spectrum band and recovering, at the baseband processor of the piece of user equipment, a set of data signals from the RF signal at the frequency of the unlicensed spectrum band.

3. The method of claim 1, wherein configuring each of the RFEs in the base station and the piece of user equipment to the unlicensed spectrum band further comprises sending a control signal to each of the base station and the piece of user equipment to change from the licensed spectrum band to the unlicensed spectrum band.

4. The method of claim 1, wherein the unlicensed spectrum band is one of a television whitespace spectrum, a citizen band radio system (CBRS) spectrum, a Wi-Fi spectrum and an n77 spectrum

5. The method of claim 4, wherein the licensed spectrum band is band43.

6. The method of claim 4, wherein the Wi-Fi spectrum is one of an Unlicensed National Information Infrastructure (UNIT) spectrum and an Industrial Scientific & Medical (ISM) spectrum.

7. A communication system, comprising:
a base station having a 3GPP compliant baseband processor, a 3GPP compliant radio front end (RFE) coupled together that communicates over a licensed spectrum band, the base station having a translation layer;
a piece of user equipment having a 3GPP compliant baseband processor and a 3GPP compliant radio front end (RFE) that communicate over the licensed spectrum band with the base station;
the baseband processor of the base station executing a plurality of lines of instructions of the translation layer so that the base station is configured to:
configure, by the translation layer, the RFE in the base station from a licensed spectrum band to an unlicensed spectrum band; and
communicate digital data between the base station and the piece of user equipment using the unlicensed spectrum band.

8. The system of claim 7, wherein the piece of user equipment further comprises a second translation layer having a plurality of lines of instructions executed by the baseband processor of the piece of user equipment wherein the piece of user equipment is configured to operate in the unlicensed spectrum band and is configured to receive an RF signal in the unlicensed spectrum band and recover, at the baseband processor of the piece of user equipment, a set of data signals from the RF signal at the frequency of the unlicensed spectrum band.

9. The system of claim 8, wherein the base station is further configured to send a control signal to the RFE of the base station to change from the licensed spectrum band to the unlicensed spectrum band.

10. The system of claim 9, wherein the piece of user equipment is further configured to send a control signal to the RFE of the piece of user equipment to change from the licensed spectrum band to the unlicensed spectrum band.

11. The system of claim 7, wherein the unlicensed spectrum band is one of a television whitespace spectrum, a citizen band radio system (CBRS) spectrum, a Wi-Fi spectrum and a n77 spectrum.

12. The system of claim 11, wherein the licensed spectrum band is band43.

13. The method of claim 11, wherein the Wi-Fi spectrum is one of an Unlicensed National Information Infrastructure (UNIT) spectrum and an Industrial Scientific & Medical (ISM) spectrum.
